(19) United States
(12) Patent Application Publication
(10) Pub. No.: US 2013/0226633 A1
(43) Pub. Date: Aug. 29, 2013

(54) Flexible Booking Of A Shared Vehicle

(71) Applicant: Zipcar Inc., (US)

(72) Inventors: Robert Brock, SW 18 5JJ (GB); Winson Wu, Cambridge, MA (US); Andrew Lee, Cambridge, MA (US); Mark Gee, Cambridge, MA (US); Kali Winkler, Boston, MA (US); John Brunton, London (GB); Goss Nuzzo-Jones, Cambridge, MA (US)

(73) Assignee: ZIPCAR INC., Cambridge, MA (US)

(21) Appl. No.: 13/774,311

(22) Filed: Feb. 22, 2013

Related U.S. Application Data
(60) Provisional application No. 61/604,190, filed on Feb. 28, 2012.

(51) Int. Cl. G06Q 10/02

(52) U.S. Cl. CPC G06Q 10/02
USPC 705/5

(57) ABSTRACT

A method, apparatus and computer program product for providing flexible booking of a shared vehicle is presented. An application for a mobile device is provided having an interface to allow a user of the mobile device to make a reservation of a shared vehicle by selecting a date the user desires to reserve the shared vehicle. The user is further able to select a location to locate at least one shared vehicle on the date. The user receives a list of vehicles proximate the location selected by the user, and an indication of available times for each of the vehicles. The user can then make a reservation of a particular shared vehicle for a particular time period on the date.

### CROSS REFERENCE TO RELATED APPLICATIONS

The present application claims the benefit of U.S. Provisional Patent Application No. 61/604,190, filed on Feb. 28, 2012, and which is incorporated herein by reference in its entirety.

### BACKGROUND

Vehicle sharing services (such as those offered by Zipcar, Inc. of Cambridge, Mass.) have become increasingly popular in the Unites States and around the world. The principles of vehicle sharing services are fairly straight forward. Individuals gain the benefits of private vehicles without the costs and responsibilities of ownership. Instead of owning one or more vehicles, a household accesses a fleet of vehicles on an as-needed basis.

In certain vehicle sharing services, the users are members and have been pre-approved to drive (e.g., background driving checks have been performed and a payment mechanism has been established). Shared vehicles are picked up and returned to a designated space. Vehicle locations are distributed throughout the service area, and often located for access by public transport. Typically, insurance and fuel costs are included in the rates.

Vehicle sharing services offer several advantages over traditional car rentals. Vehicle sharing services are not limited by office hours, and are available twenty four hours a day, seven days a week. Reservation, pickup, and return for vehicles of a vehicle sharing services is self-service. Shared vehicles can be rented by the minute, by the hour, as well as by the day.

### SUMMARY

Conventional mechanisms such as those explained above suffer from a variety of deficiencies. Most users of a car sharing service are more interested in the proximity of the shared vehicle rather than the exact time a vehicle is available.

Embodiments of the invention significantly overcome such deficiencies and provide mechanisms and techniques that provide a method for searching for available shared vehicles which takes into account the proximity-centric availability of the shared vehicle. The user uses their mobile device running a car-sharing reservation application, and selects the desired day for the reservation. The user also selects a location to begin filtering the search to vehicles that are near the user-entered location. The user then receives a list of available vehicles, and an indication of available times for each of the available vehicles. The user can then make a reservation for a particular shared vehicle for a particular time period on the desired date. The user can also easily change the start time, end time or duration of the reservation.

In a particular embodiment of a method for providing flexible booking of a shared vehicle the method includes providing, on a mobile device, an interface to allow a user of the mobile device to make a reservation of a shared vehicle by selecting a date the user desires to reserve the shared vehicle. The method further includes allowing the user of the mobile device to select a location to locate at least one shared vehicle on the date. The method also includes receiving, by the user on the mobile device, a list of vehicles proximate the location selected by the user, and an indication of available times for each of the vehicles. Additionally the method includes making a reservation, by the user on the mobile device, of a particular vehicle for a particular time period on the date the vehicle is available.

Other embodiments include a computer readable medium having computer readable code thereon for providing flexible booking of a shared vehicle. The computer readable medium includes instructions for providing, on a mobile device, an interface to allow a user of the mobile device to make a reservation of a shared vehicle by selecting a date the user desires to reserve the shared vehicle. The computer readable medium further includes instructions for allowing the user of the mobile device to select a location to locate at least one shared vehicle on the date. The computer readable medium also includes instructions for receiving, by the user on the mobile device, a list of vehicles proximate the location selected by the user, and an indication of available times for each of the vehicles. Additionally the computer readable medium includes instructions for making a reservation, by the user on the mobile device, of a particular one of the vehicles for a particular time period on the date which the particular vehicle is available.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides flexible booking of a shared vehicle as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing flexible booking of a shared vehicle as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Zipcar Inc, of Cambridge Mass.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 comprises a depiction of a mobile device running a flexible scheduling application for browsing available vehicles by a date;

FIG. 2 comprises a depiction of a mobile device running a scheduling application for browsing available vehicles by a time window;

FIG. 3 comprises a depiction of a mobile device running a flexible scheduling application for providing current results;

FIG. 4 comprises a depiction of a mobile device running a flexible scheduling application for browsing and selecting available times for a vehicle via touch and time selection;

FIG. 5A comprises a depiction of a mobile device running a flexible scheduling application for selecting a start time via touch interface for an available vehicle;

FIG. 5B comprises a depiction of a mobile device running a flexible scheduling application for selecting an end time via touch interface for reserving an available vehicle;

FIG. 6A comprises a depiction of a mobile device running a flexible scheduling application for changing or canceling a reservation for a vehicle;

FIG. 6B comprises a depiction of a mobile device running a flexible scheduling application for changing a reservation for a vehicle;

FIG. 7 depicts a flow diagram of a particular embodiment of a method for flexible booking of a shared vehicle in accordance with embodiments of the invention; and

FIG. 8 illustrates an example computer system architecture for a computer system that performs flexible booking of a shared vehicle in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

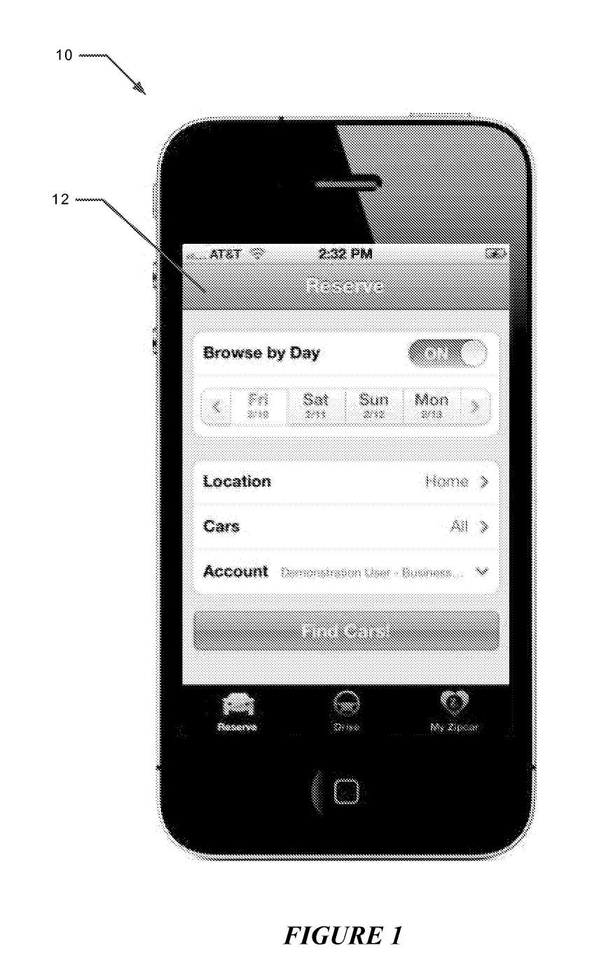

Referring now to FIG. 1, a mobile device 10 is shown running a flexible booking application 12 for making reservations in a vehicle sharing service. While mobile device 10 is shown as a smart phone, it should be understood that any type of mobile device, including but not limited to tablets, laptops, and the like could be used.

There may be certain instances where a user of a vehicle sharing service desires to browse available cars for a particular day. A user may require use of a shared vehicle for a few hours on a weekend to run a few errands, but the user wants to avoid having to keep going back and guessing available times. A user may have a favorite shared vehicle which is currently booked, and would like to know when and for how long the favorite vehicle will be free in order to make a reservation for the favorite vehicle.

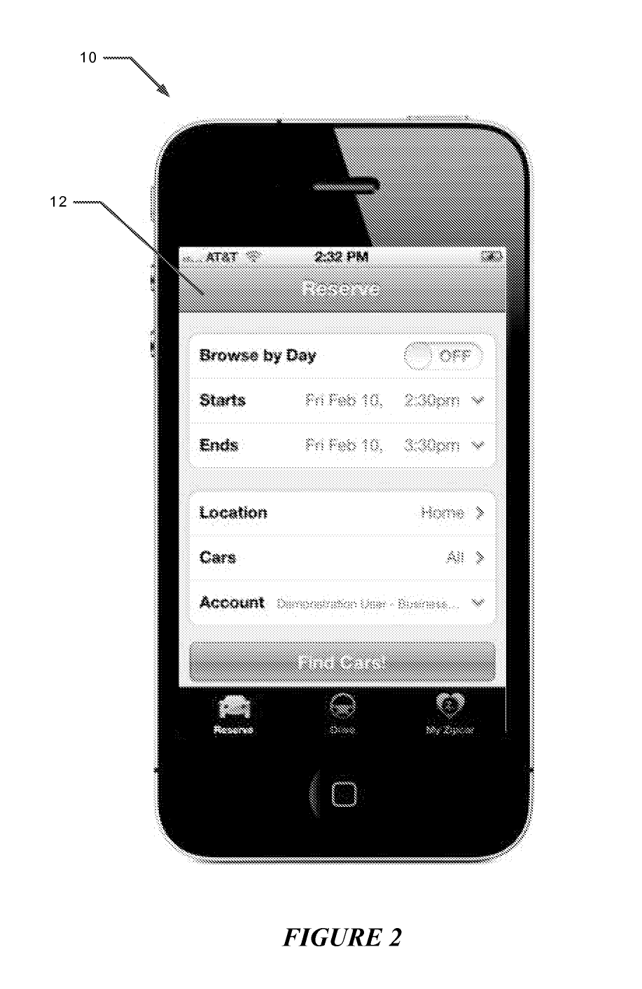

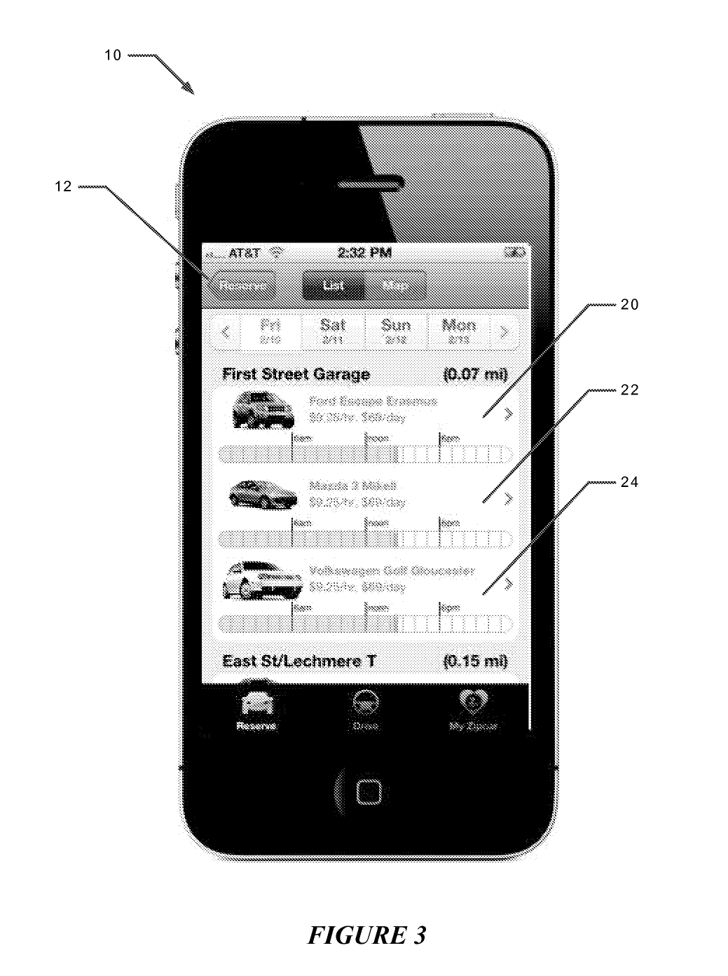

FIG. 2 shows the flexible booking application 12 with the browse by day feature turned off. This allows the user to find vehicles within a specific time range. FIG. 3 shows a results list resulting from a browse by day selection made in FIG. 1. The available vehicles 20, 22 and 24 are shown for the selected day in the area selected by the user. Each vehicle 20, 22 and 24 is shown along with the rate(s) and a graph of the availability for the selected day. The user can select a different day and get an updated list of nearby vehicles, which have different availability throughout the day.

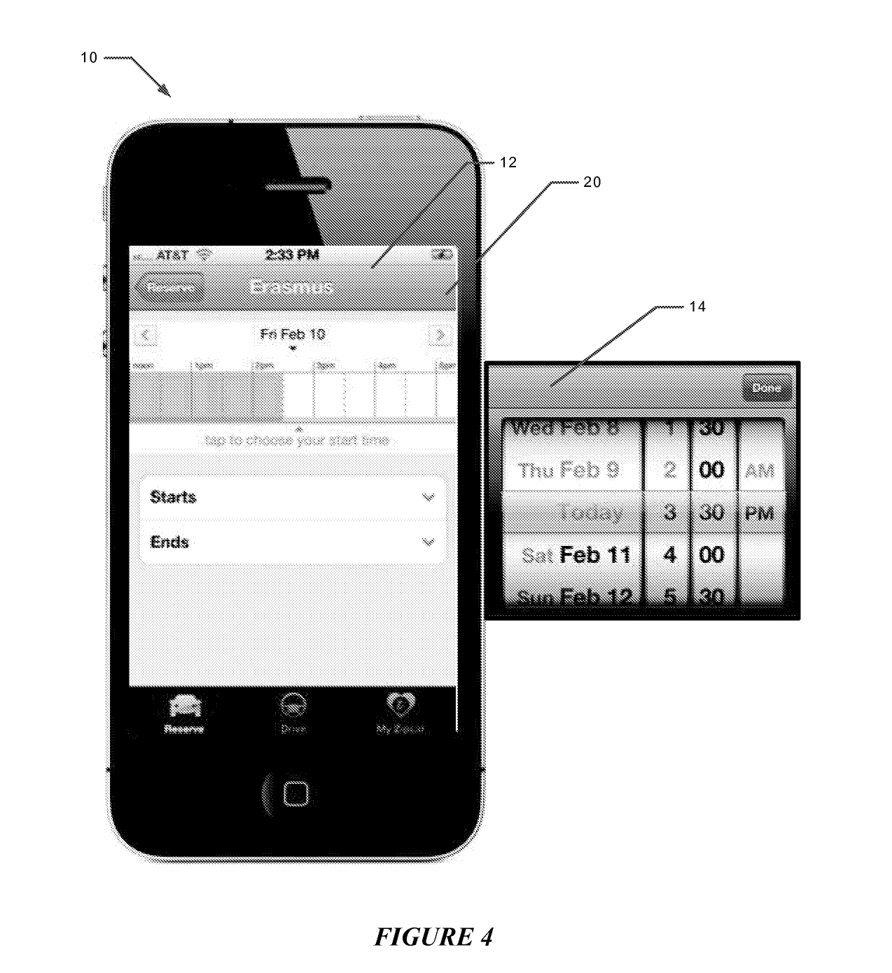

Referring now to FIG. 4, the flexible booking application 12 is shown wherein a particular vehicle 20 has been chosen. A reservation grid is displayed allowing the member to see and select available times and dates for the particular vehicle. The gray area indicates the vehicle is unavailable (either the time is past, member is ineligible, and or the vehicle is reserved). The member may also be shown their existing reservations on the vehicle should they have created them prior to this action. This is shown as light green tiles. Also shown is a time picker 14 which can be used to select a date and time to reserve the vehicle.

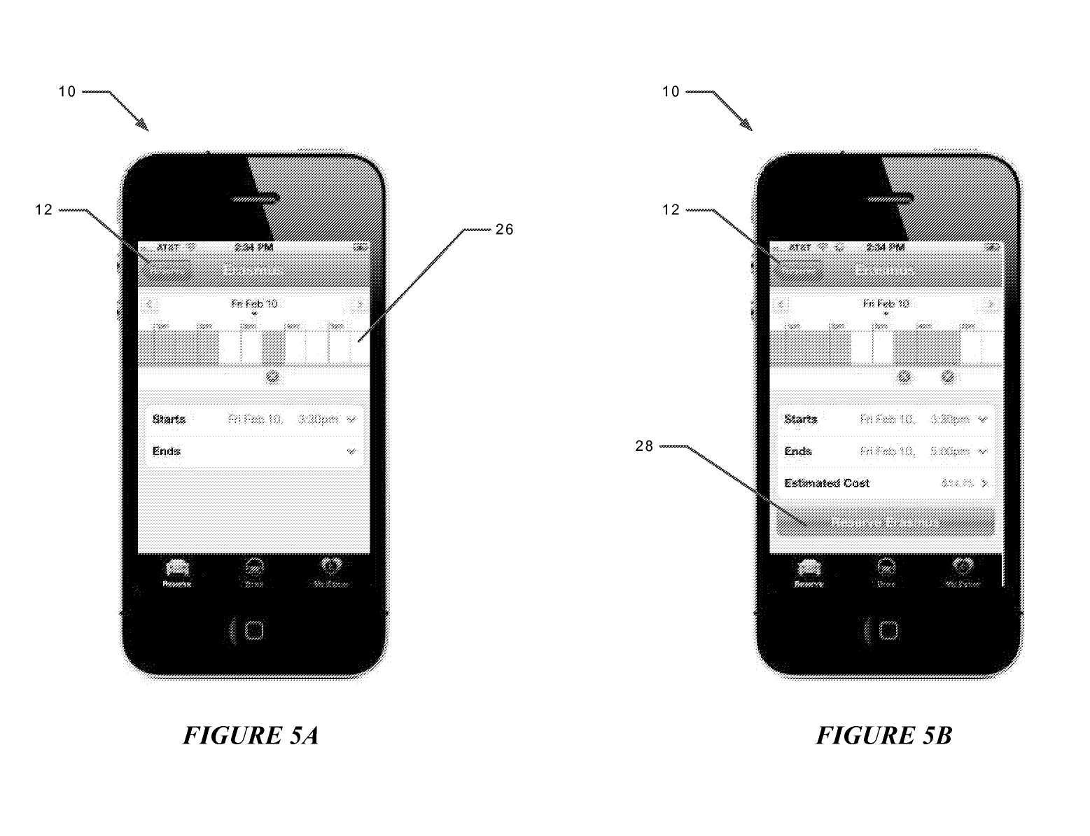

FIGS. 5A and 5B show the reservation grid 26 of the flexible booking application 12 as a reservation is being made. In FIG. 5A, the member has selected a start time (3:30 pm on Friday February 10^{th}) as shown by the block of the reservation being set to green. Also, a graphical reset button is provided below the start time of the reservation to allow the member to easily clear the reservation selection made. In FIG. 5B, the member has selected an end time (5:00 pm on Friday February 10^{th}) as shown by the blocks of the reservation being set to green. Also, a second reset button is provided below the end time of the reservation to allow the member to easily clear the reservation selection. Once the end time is selected an estimated cost is also calculated and displayed. The reverse of this process is also an option for the member, they can choose to select an end time first and then select a start time, resulting in the same process. Having selected the start time, the end time and getting an estimated cost, the member can book the reservation by touching the “Reserve” button 28.

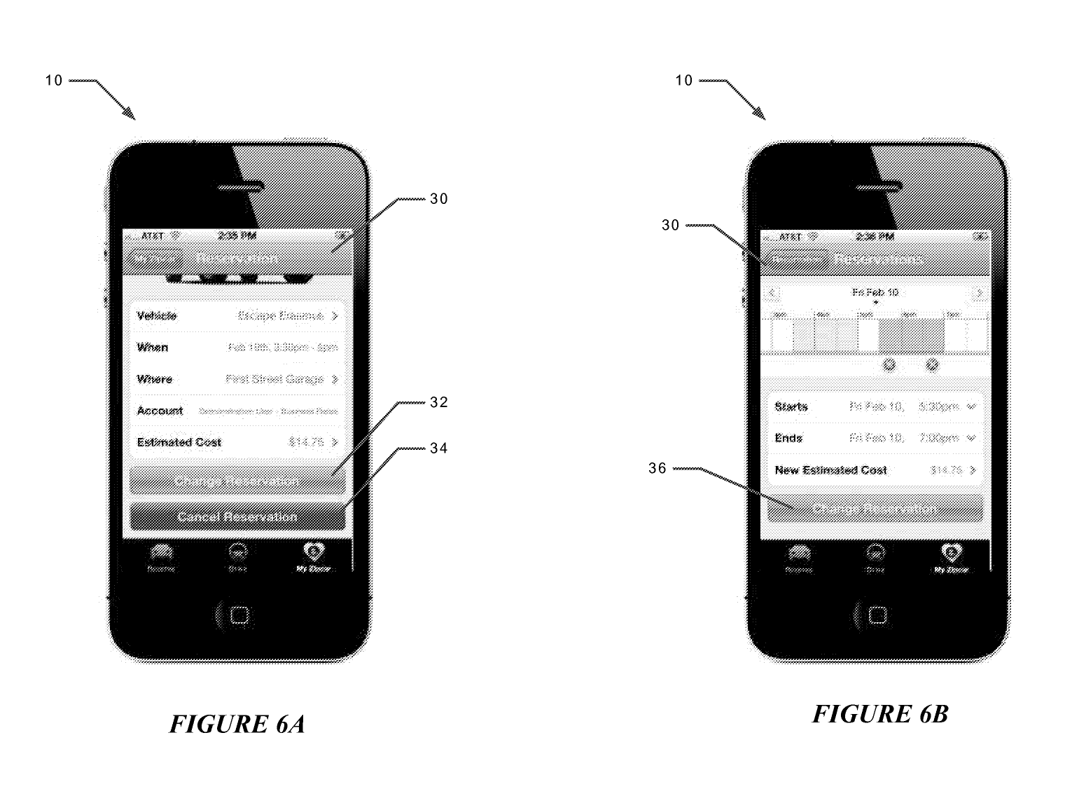

FIGS. 6A and 6B show the screens for modifying an existing reservation. In FIG. 6A the current reservation 30 is shown. This reservation 30 is for the vehicle “Escape Erasmus” for February 10 from 3:30 pm to 5:00 pm. The vehicle is located in the First Street Garage. Also shown are the account information and the estimated cost. The member is given the option of changing the reservation by tapping button 32 or canceling the reservation by tapping button 34. In FIG. 6B, the member has changed the reservation 30 from the original 3:30 pm to 5:00 pm to a new time of 5:30 pm to 7:00 pm. This selection is made in a similar fashion to the reservation creation process shown in FIGS. 5A and 5B. The light green indicates the original reservation times, which may be visible. The user can confirm the reservation change by selecting the “Change Reservation” button 36.

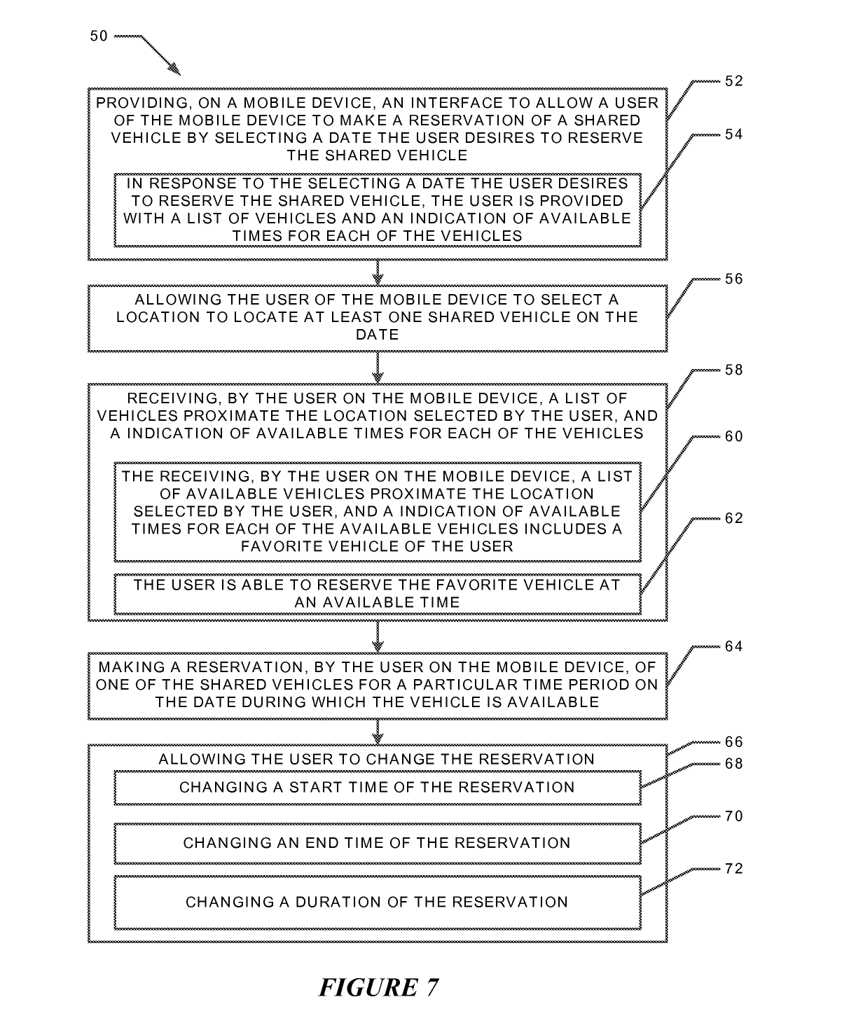

A flow chart of a particular embodiment of the presently disclosed method is depicted in FIG. 7. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 7, a particular embodiment of a method 50 for providing flexible booking of a shared vehicle is shown. Method 50 begins with processing block 52 which discloses providing, on a mobile device, an interface to allow a user of the mobile device to make a reservation of a shared vehicle by selecting a date the user desires to reserve the shared vehicle. As further shown in processing block 54, in response to the selecting a date the user desires to reserve the shared vehicle, the user is provided with a list of vehicles and an indication of available times for each of the vehicles.

Processing block 56 states allowing the user of the mobile device to select a location to locate at least one shared vehicle on the date. This acts as a filter to narrow down the list of available and nearby vehicles.

Processing block 58 recites receiving, by the user on the mobile device, a list of vehicles proximate the location selected by the user, and an indication of available times for each of the vehicles. As shown in processing block 60, in certain instances the list of available vehicles may include a “favorite” vehicle of the user. As further shown in processing block 62, the user is able to reserve their favorite vehicle at an available time.

Processing continues at processing block 64 which discloses making a reservation, by the user on the mobile device, of a particular one of the vehicles for a particular time period on the date selected in block 52. Processing block 66 states allowing the user to change the reservation. As shown in processing blocks 68, 70 and 72 respectively, the user can change a start time of the reservation, change an end time of the reservation and/or change the duration of the reservation.

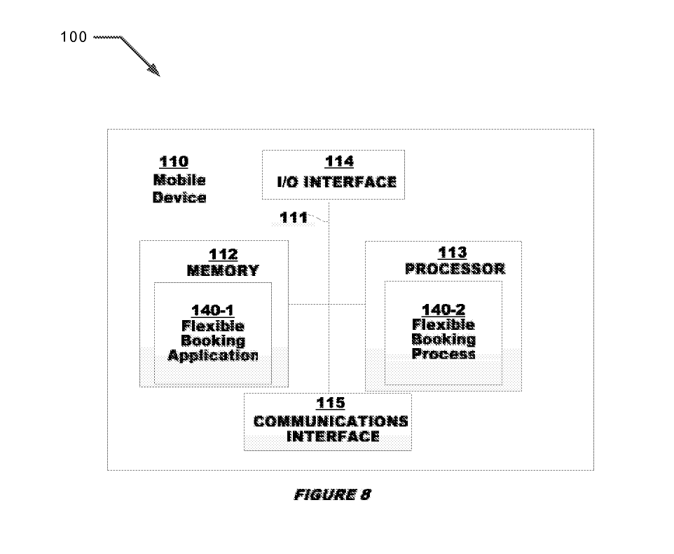

FIG. 8 is a block diagram illustrating example architecture of a computer system (e.g., a mobile device) 110 that executes, runs, interprets, operates or otherwise performs a flexible booking of a shared vehicle application 140-1 and flexible booking of a shared vehicle process 140-2 suitable for use in explaining example configurations disclosed herein. The computer system 110 may be any type of computerized device such as a personal computer, workstation, portable computing device, console, laptop, network terminal or the like. An input device 116 (e.g., one or more customer/developer controlled devices such as a keyboard, mouse, etc.) couples to processor 113 through I/O interface 114, and enables a customer 108 to provide input commands, and generally control the graphical customer interface 160 that the flexible booking of a shared vehicle application 140-1 and process 140-2 provides on the display 130. Essentially, the graphical user interface 160 is where the customer 108-1 performs their ‘online banking’, specifying which bills are to be paid electronically, when those bills are to be paid, and the amount to be paid. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a flexible booking of a shared vehicle application 140-1 as explained herein. The flexible booking of a shared vehicle application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a flexible booking of a shared vehicle application 140-1. Execution of a flexible booking of a shared vehicle application 140-1 in this manner produces processing functionality in the flexible booking of a shared vehicle process 140-2. In other words, the flexible booking of a shared vehicle process 140-2 represents one or more portions or runtime instances of a flexible booking of a shared vehicle application 140-1 (or the entire a flexible booking of a shared vehicle application 140-1) performing or executing within or upon the processor 113 in the computerized device 110 at runtime.

It is noted that example configurations disclosed herein include the flexible booking of a shared vehicle application 140-1 itself (i.e., in the form of un-executed or non-performing logic instructions and/or data). The flexible booking of a shared vehicle application 140-1 may be stored on a computer readable medium (such as a floppy disk), hard disk, electronic, magnetic, optical, or other computer readable medium. A flexible booking of a shared vehicle application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a flexible booking of a shared vehicle application 140-1 in the processor 113 as the flexible booking of a shared vehicle process 140-2. Those skilled in the art will understand that the computer system 110 may include other processes and/or software and hardware components, such as an operating system not shown in this example.

A display 130 need not be coupled directly to computer system 110. For example, the flexible booking of a shared vehicle application 140-1 can be executed on a remotely accessible computerized device via the network interface 115. In this instance, the graphical customer interface 160 may be displayed locally to a customer 108 of the remote computer, and execution of the processing herein may be client-server based.

During operation, processor 113 of computer system 100 accesses memory system 112 via the interconnect 111 in order to launch, run, execute, interpret or otherwise perform the logic instructions of the flexible booking of a shared vehicle application 140-1. Execution of flexible booking of a shared vehicle application 140-1 produces processing functionality in flexible booking of a shared vehicle process 140-2. In other words, the flexible booking of a shared vehicle process 140-2 represents one or more portions of the flexible booking of a shared vehicle application 140-1 (or the entire application) performing within or upon the processor 113 in the computer system 100.

It should be noted that, in addition to the flexible booking of a shared vehicle process 140-2, embodiments herein include the flexible booking of a shared vehicle application 140-1 itself (i.e., the un-executed or non-performing logic instructions and/or data). The flexible booking of a shared vehicle application 140-1 can be stored on a computer readable medium such as a floppy disk, hard disk, or optical medium. The flexible booking of a shared vehicle application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of flexible booking of a shared vehicle application 140-1 in processor 113 as the flexible booking of a shared vehicle process 140-2. Those skilled in the art will understand that the computer system 100 can include other processes and/or software and hardware components, such as an operating system that controls allocation and use of hardware resources associated with the computer system 100.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

The invention has been described above in detail with reference to the preferred embodiment thereof. However, as is readily understood by those skilled in the art, other embodiments are equally possible within the scope of the present invention, as defined by the appended claims.

We claim:

1. A method for providing flexible booking of a shared vehicle, comprising:
providing, on a mobile device, an interface to allow a user of said mobile device to make a reservation of a shared vehicle by selecting a date said user desires to reserve the shared vehicle;
allowing said user of said mobile device to select a location to locate at least one shared vehicle on said date;
receiving, by said user on said mobile device, a list of vehicles proximate the location selected by the user, and a indication of available times for each of said vehicles; and
making a reservation, by said user on said mobile device, of a particular one of said vehicles for a particular time period on said date during which the particular vehicle is available.

2. The method of claim 1 further comprising allowing said user to change said reservation.

3. The method of claim 2 wherein said allowing said user to change said reservation comprises changing a start time of said reservation.

4. The method of claim 2 wherein said allowing said user to change said reservation comprises changing an end time of said reservation.

5. The method of claim 2 wherein said allowing said user to change said reservation comprises changing a duration of said reservation.

6. The method of claim 1 wherein, in response to said selecting a date said user desires to reserve the shared vehicle, said user is provided with a list of vehicles and an indication of available times for each of said vehicles.

7. The method of claim 1 wherein said receiving, by said user on said mobile device, a list of vehicles proximate the location selected by the user, and an indication of available times for each of said vehicles includes a favorite vehicle of said user.

8. The method of claim 7 wherein said user is able to reserve said favorite vehicle at an available time.

9. A non-transitory computer readable storage medium having computer readable code thereon for providing flexible booking of a shared vehicle, the medium including instructions in which a computer system performs operations comprising:
providing, on a mobile device, an interface to allow a user of said mobile device to make a reservation of a shared vehicle by selecting a date said user desires to reserve the shared vehicle;
allowing said user of said mobile device to select a location to locate at least one shared vehicle on said date;
receiving, by said user on said mobile device, a list of vehicles proximate the location selected by the user, and an indication of available times for each of said vehicles; and
making a reservation, by said user on said mobile device, of a particular one of said vehicles for a particular time period on said date during which the particular vehicle is available.

10. The computer readable storage medium of claim 9 further comprising instructions for allowing said user to change said reservation.

11. The computer readable storage medium of claim 10 wherein said instructions for allowing said user to change said reservation comprises instructions for changing a start time of said reservation.

12. The computer readable storage medium of claim 10 wherein said instructions for allowing said user to change said reservation comprises instructions for changing an end time of said reservation.

13. The computer readable storage medium of claim 10 wherein said instructions for allowing said user to change said reservation comprises instructions for changing a duration of said reservation.

14. The computer readable storage medium of claim 9 further including instructions wherein, in response to said selecting a date said user desires to reserve the shared vehicle, said user is provided with a list of vehicles and an indication of available times for each of said vehicles.

15. The computer readable storage medium of claim 9 further including instructions wherein said receiving, by said user on said mobile device, a list of vehicles proximate the location selected by the user, and an indication of available times for each of said vehicles includes a favorite vehicle of said user.

16. The computer readable storage medium of claim 15 further comprising instructions wherein said user is able to reserve said favorite vehicle at an available time.

17. A computer system comprising:
a memory;
a processor;
a communications interface;
an interconnection mechanism coupling the memory, the processor and the communications interface; and
wherein the memory is encoded with an application providing flexible booking of a shared vehicle, that when performed on the processor, provides a process for processing information, the process causing the computer system to perform the operations of:
providing, on a mobile device, an interface to allow a user of said mobile device to make a reservation of a shared vehicle by selecting a date said user desires to reserve the shared vehicle;
allowing said user of said mobile device to select a location to locate at least one shared vehicle on said date;
receiving, by said user on said mobile device, a list of vehicles proximate the location selected by the user, and an indication of available times for each of said vehicles; and
making a reservation, by said user on said mobile device, of a particular one of said vehicles for a particular time period on said date during which the particular vehicle is available.

18. The computer system of claim 17 further comprising allowing said user to change said reservation.

19. The computer system of claim 17 wherein, in response to said selecting a date said user desires to reserve the shared vehicle, said user is provided with a list of vehicles and an indication of available times for each of said vehicles.

20. The computer system of claim 17 wherein said receiving, by said user on said mobile device, a list of available vehicles proximate the location selected by the user, and an indication of available times for each of said vehicles includes a favorite vehicle of said user and wherein said user is able to reserve said favorite vehicle at an available time.
